(19) United States
(12) Patent Application Publication
(10) Pub. No.: US 2016/0196407 A1
(43) Pub. Date: Jul. 7, 2016

(54) ENTITY COHORT DISCOVERY AND ENTITY PROFILING

(71) Applicant: Amino, Inc., San Francisco, CA (US)

(72) Inventors: Jorge A. Caballero, Menlo Park, CA (US); Abhinav Chowdary Yarlagadda, San Francisco, CA (US); Farid Jamshidian, South San Francisco, CA (US); Kate M. Lewis, San Francisco, CA (US); Eithon Michael Galinato Cadag, Foster City, CA (US); James Lyon Fingal, San Francisco, CA (US); Nicholas C. Dunkman, San Francisco, CA (US); Kunal Dhiren Shah, San Francisco, CA (US); Willard Kirk Strauser, Alameda, CA (US); Michael H. Lin, Saratoga, CA (US); Abraham M. Othman, San Francisco, CA (US); David A. Vivero, San Francisco, CA (US); Mary Audrey Hampden, Alameda, CA (US); Roger Billerey-Mosier, Alameda, CA (US); Sumul Mahendra Shah, Alameda, CA (US)

(21) Appl. No.: 14/990,766

(22) Filed: Jan. 7, 2016

Related U.S. Application Data
(63) Continuation-in-part of application No. 14/638,227, filed on Mar. 4, 2015.
(60) Provisional application No. 62/100,890, filed on Jan. 7, 2015.

(51) Int. Cl. G06F 19/00; G06F 17/30

(52) U.S. Cl. CPC G06F 19/3443; G06F 19/3481; G06F 19/322; G06F 19/328; G06F 17/30864; G06F 17/30525

(57) ABSTRACT

Disclosed are systems and techniques for providing a master health entity index and a data analysis mechanism designed for entity cohort discovery and entity profiling. The entity can be a healthcare facility that diagnoses or treats health conditions and diseases (e.g., hospital, clinic), individuals (e.g., providers, patients, caregivers), healthcare data (e.g., medical conditions, treatments, diagnostic studies, health outcomes), etc. For example, a data analysis mechanism may identify distinctive patient cohorts based on what happened to patients in a hospital and why the occurrence happened, reconstruct timelines of healthcare events from fragmented medical data, and leverage the existing electronic health data to generate comprehensive profiles of healthcare entities.

### CROSS-REFERENCE TO RELATED APPLICATION(S)

This application is a continuation in part of U.S. patent application Ser. No. 14/638,227, filed on Mar. 4, 2015, which claims the benefit of U.S. Provisional Patent Application No. 62/100,890, filed on Jan. 7, 2015, each of which applications is incorporated by reference herein in its entirety.

### FIELD OF INVENTION

Various embodiments relate generally to a data analysis mechanism. More specifically, various embodiments relate to a data analysis mechanism designed for cohort discovery and profiling of healthcare entities.

### BACKGROUND

Service providers and device manufacturers are continually challenged to identify potentially fraudulent healthcare charges using claims data, reconstruct timelines of healthcare events from fragmented medical data and recognize potential sources of cost overruns.

### SUMMARY

Systems and methods are described herein that provide a master health entity index and a data analysis mechanism designed for entity cohort discovery and entity profiling by analyzing insurance claim data of patient populations.

According to one embodiment, a method comprises a master health entity index and a data analysis mechanism designed for entity cohort discovery and entity profiling. The entity can be a healthcare facility that diagnoses or treats health conditions and diseases (e.g., hospital, clinic), individuals (e.g., providers, patients, caregivers), healthcare data (e.g., medical conditions, treatments, diagnostic studies, health outcomes), etc. For example, a data analysis mechanism may identify distinctive patient cohorts based on what happened to patients in a hospital and why the occurrence happened, reconstruct timelines of healthcare events from fragmented medical data, and leverage existing electronic health data to generate comprehensive profiles of healthcare entities and the relationships between said healthcare entities.

According to another embodiment, an apparatus comprises a processor and a memory that includes computer program code for one or more computer programs. The computer program code can be configured to provide a master health entity index and a data analysis mechanism designed for entity cohort discovery and entity profiling by analyzing the insurance claim data of patient populations.

According to another embodiment, a computer-readable storage medium carries one or more sequences of one or more instructions which, when executed by one or more processors, cause an apparatus to provide a master health entity index and a data analysis mechanism designed for entity cohort discovery and entity profiling by analyzing the insurance claim data of patient populations.

The system disclosed in the present application automatically analyzes a large quantity of historical data to improve medical treatment decisions by extracting relevant information and building a generic framework applicable to a number of attributes. The system is capable of handling data covering billions of patient-provider interactions, which could take at least tens of years of manpower to process manually. Once primed, the system can then simultaneously handle millions of user queries regarding similar patients and the associated operations and return results within seconds. With a conventional approach, it could easily take weeks to months to yield a response to one of those queries. The historical data typically describes procedures performed on patients in a variety of details. In some embodiments, the system first selects an initial set of procedures from the historical data using a set of healthcare criteria, which can correspond to common medical conditions (e.g., prostate cancer), specific patient conditions (e.g., age, gender), etc. Such selection and focus on specific procedures saves unnecessary use of computing resources and enables a custom, accurate analysis. From the initial set, the system further selects a refined set of procedures that are specific to the healthcare criteria (e.g., chemotherapy as opposed to routine physical examination). The system can do so by examining certain portions of the historical data that do not satisfy the set of healthcare criteria. Such additional selection and focus on specific procedures further improves computing resource utilization and analysis quality. The system next classifies the refined set of procedures into groups based on certain relationships among the procedures. For example, those procedures that belong to the same group can be alternatives of one another without being performed together on the same patient. Such clustering of procedures therefore enables the identification of a common treatment plan by including different combinations of the groups (or combinations of at most one procedure from each of the groups) into the treatment plan, while allowing for alternatives within each group, thereby achieving accuracy in representing treatment plans without losing flexibility.

Upon identifying different sequences of procedures with respect to a timeline, the system can associate a variety of attributes with each procedure included in the treatment plan, such as cost, duration, success rate, effectiveness, provider, facility, etc. The system can then model a “typical” treatment plan by aggregating values of these attributes in relevant performances of each procedure across part of or the entire treatment plan. A new attribute can be applied as long as the aggregation of values over multiple performances and the combination of aggregate values across part of or the entire treatment plan are defined for the attribute; such definition can depend on the nature of the attribute, nature of the model, etc. The system therefore offers a comprehensive and powerful analytical framework for understanding treatment plans. Furthermore, the aggregate values correspond to a large number of performances of the procedures and thus represent “typical” attribute values associated with the treatment plan, which are unavailable with existing approaches of looking at isolated instances but can prove useful in several ways. Specifically, these aggregate values enable healthcare professionals and patients to make solid, educated predictions regarding future performances of specific treatment plans, which in turn allow them to properly choose treatment plans and plan for the performance of the treatment plan. The aggregate values further allow the healthcare professionals to detect abnormalities and frauds in past performances of those treatment plans, thereby prompting an increase in the quality of future performances. Certainly, by identifying different sequences of procedures, the system also enables a comparative study of different, common treatment plans in detail. Therefore, through a big-data approach with multiple steps that each aim to minimize the usage of computing resources and maximize the accuracy of analysis results, the system performs efficient information discovery and allows healthcare professionals and patients alike to make informed decisions regarding treatment plans.

In addition, for various example embodiments of the invention, the following is applicable: a method comprising facilitating processing data. The data can be based on (or derived at least in part from) any one or any combination of methods (or processes) disclosed in this application as relevant to any embodiment of the invention.

For various example embodiments of the invention, the following is also applicable: a method for configuring at least one interface to allow access to at least one service, the at least one service being configured to perform any one or any combination of network or service provider methods (or processes) disclosed in this application.

For various example embodiments of the invention, the following is also applicable: a method for creating and/or modifying (1) at least one device user interface element and/or (2) at least one device user interface functionality. These devices may be based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides. The mobile device can be a wearable device such as a Fitbit, Smartwatch, Google Glass, mobile communication device and so on.

Still other aspects, features, and advantages of the invention are readily apparent from the following Detailed Description when illustrated by a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

These and other objects, features and characteristics of the present embodiments will become more apparent to those skilled in the art from a study of the following Detailed Description in conjunction with the appended claims and drawings, all of which form a part of this specification.

The embodiments of the invention are illustrated by way of example, and not by way of limitation, in the figures of the accompanying drawings:

FIG. 1 is a diagram of a system capable of generating a data analysis mechanism designed for entity cohort discovery and entity profiling, according to one embodiment;

FIG. 2 is a screenshot of a report that identifies entity cohorts based on medical procedure, according to one embodiment;

FIG. 3 is a flow diagram of a process for generating a reconstructed timeline of healthcare events from fragmented medical data, according to one embodiment;

FIG. 4 is a flow diagram of a process for leveraging the existing electronic health data to generate comprehensive profiles of healthcare entities, according to one embodiment;

FIG. 5 is a flow diagram of a process for generating a master health entity index, according to one embodiment;

FIG. 6 illustrates an example of the phases of raw time-series medical data for patient cohorts and decision groups, according to one embodiment;

FIG. 7 illustrates an example of the extension of the patient cohort and decision group identification process for providers, according to one embodiment;

FIG. 8 illustrates an example of the proceeding to find affiliated providers from identification of similar providers, according to one embodiment;

FIG. 9 illustrates an example of the direct calculation of likely costs based on patient clusters and discrete decision groups, according to one embodiment;

FIGS. 10A-10F illustrate examples of various graphical user interfaces of healthcare applications generated by a system, such as the system of FIG. 1, for providing personalized cost, treatment and outcome predictions based on entity cohort discovery and entity profiling, according to one embodiment;

FIG. 11 is a diagrammatic representation of a machine in the example form of a computer system within which a set of instructions for causing the machine to perform any one or more of the methodologies discussed herein may be executed; and

FIG. 12 illustrates an example ordered combination of event clusters for prostate cancer.

### DETAILED DESCRIPTION

Examples of methods, apparatuses, and computer programs for generating a master health entity index and a data analysis mechanism designed for entity cohort discovery and entity profiling are described below. In the following description, for the purposes of explanation, numerous specific details are set forth in order to provide a thorough understanding of the embodiments of the invention. However, it will be apparent to one skilled in the art that the embodiments of the invention may be practiced without these specific details or with an equivalent arrangement. In other instances, well-known structures and devices are shown in block diagram form in order to avoid unnecessarily obscuring the embodiments of the invention.

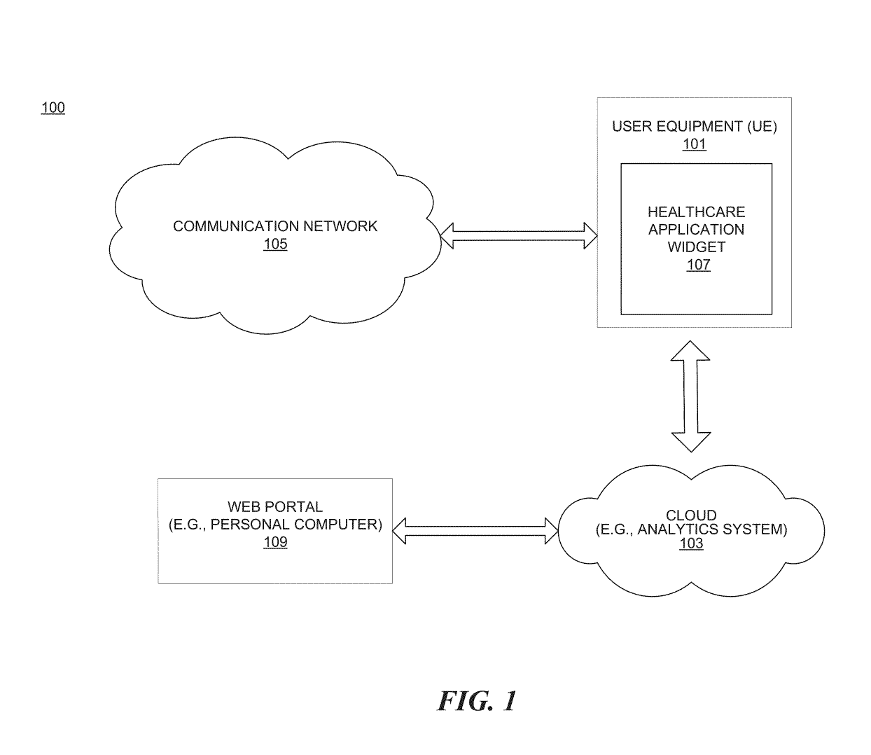

FIG. 1 is a diagram of a system 100 capable of generating a data analysis mechanism designed for entity cohort discovery and entity profiling by analyzing the insurance claims data of patient populations. A “healthcare entity” or “entity,” as either term is used herein, is intended to include healthcare facilities that diagnose or treat health conditions and diseases (e.g., hospital, clinic), individuals (e.g., providers, patients, caregivers), healthcare data (e.g., medical conditions, treatments, diagnostic studies, health outcomes), etc.

As shown in FIG. 1, the system 100 can comprise a user equipment 101 (also referred to as “UE”) having a healthcare application widget 107 that is connected to a web portal 109 (e.g., personal computer) via a cloud network 103. The UE 101 may be a device that is connectable to the web portal 109 through a wired or wireless connection. By way of example, a communication network 105 of the system 100 includes one or more data networks. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network (e.g., a proprietary cable or fiber-optic network), and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium (e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof).

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, the accessories and peripherals of these devices, or any combination thereof. It is also contemplated that the UE 101 can support any type of interface to the user (such as “wearable” circuitry, etc.).

By way of example, the UE 101, the cloud 103 and the web portal 109 communicate with one another and other components of the communication network 105 using well known, new, or still developing protocols. In this context, a protocol includes a set of rules defining how the network nodes within the communication network 105 interact with one another based on information sent over the communication links. The protocols are effective at different layers of operation within each node, from generating and receiving physical signals of various types to selecting a link for transferring those signals, to the formatting of information indicated by those signals, to identifying which software application executing on a computer system sends or receives the information. The conceptually different layers of protocols for exchanging information over a network are described in the Open Systems Interconnection (OSI) Reference Model.

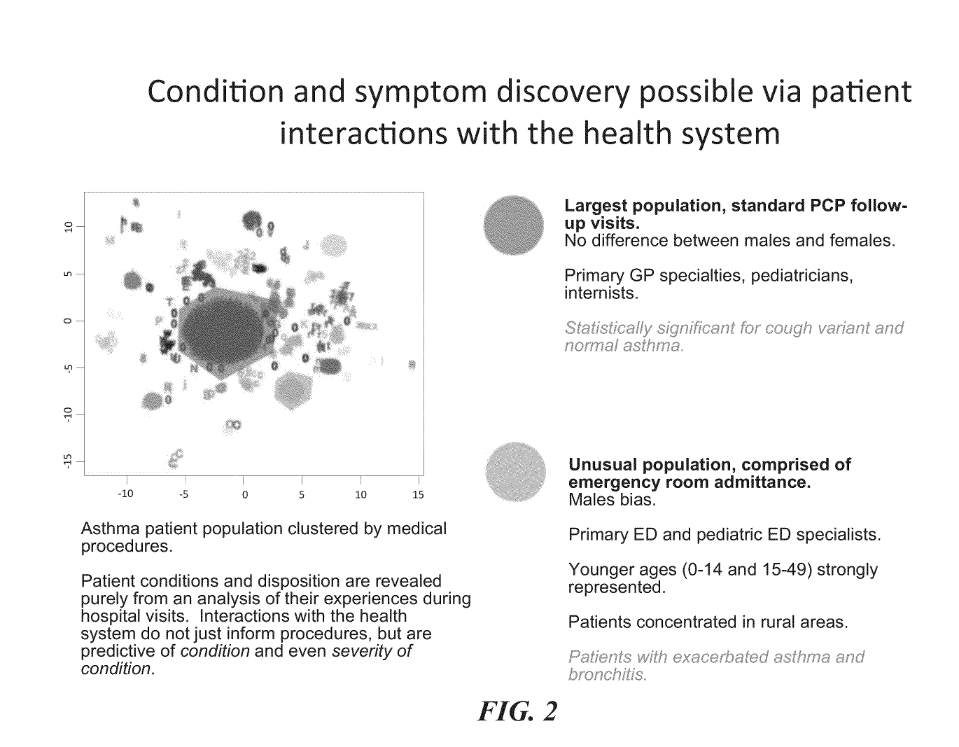

FIG. 2 is a screenshot of a report that identifies entity cohorts based on medical procedure, according to one embodiment. By applying the system's statistical methodologies sequentially to large subsets of health data, the system can identify distinctive patient cohorts and describe the nature of the differences between cohorts along a plurality of domains that include, but are not limited to, patient age, patient gender, patient comorbidities, care provider specialty, facility type, procedure(s) performed, etc. For example, the methods described could be used to scale production of narrative consumer-oriented health-related content, create highly customizable reports about treatment patterns by provider specialty type, practice setting, primary diagnosis, etc. The method may also be used to create multidimensional care provider practice profiles, identify potentially fraudulent healthcare charges using claims data, and discover, define, and/or measure healthcare outcomes.

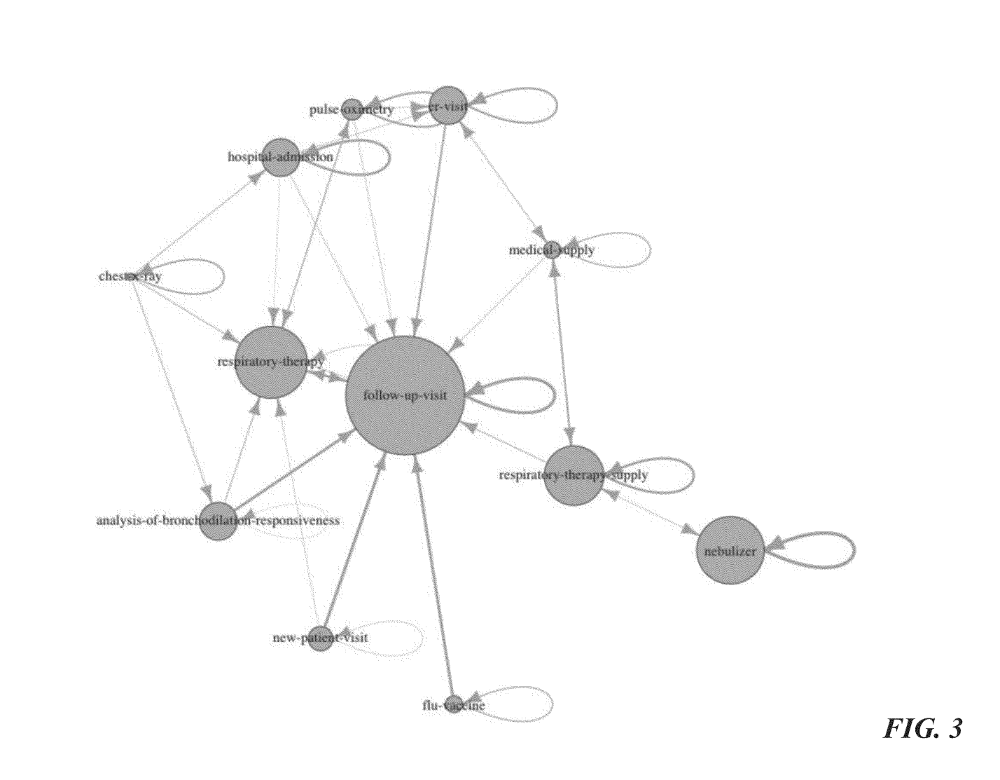

FIG. 3 is a flow diagram of a process for generating a reconstructed timeline of healthcare events from fragmented medical data, according to one embodiment. By applying the system's statistical methodologies in a sequence to large subsets of health data, the system can re-create probabilistic timelines that reflect courses of diagnosis and/or treatment from a plurality of perspectives. In other words, the system can reconstruct timelines of healthcare events from fragmented medical data, generate a report that describes the application of these methods to the development of analytical reports as well as narrative content with commercial value, and describe the method's application to the discovery of insights relevant to healthcare. Beginning with the technique in paragraph [29], entity cohorts can represent classes of encounters within a healthcare system recorded in electronic medical data. These classes can be used as an archetypal reference, such as for statistical classification purposes, and static or real-time patients interactions with a healthcare system as recorded in electronic medical data can be matched to these archetypal references. Using probabilistic techniques such as maximum likelihood, timelines of patient interactions with a healthcare system can be endogenously reconstructed based on the archetypal reference encounters without any prior assumptions or suppositions. That is, patient interactions and encounters are discovered and health timelines over possibly lengthy periods are reconstructed automatically. Substantial cost savings may be realized by informing healthcare consumers about health conditions, treatment options, success factors, and costs. Full cost savings are often unrealized due, in part, to knowledge gaps that exist across the spectrum of healthcare. Optimizations in care may also be realized by identifying paths through the probabilistic reconstructed timeline that have favorable outcomes. In some embodiments, the system leverages (e.g., by accessing, processing, and converting) existing electronic health data into a usable format. The usable health data can be used to generate comprehensive reports that include chronological illustrations of prior or current courses of treatment. The system can enable cost savings and favorable patient outcomes by identifying sources of high-cost care and/or high risk, thereby guiding resource allocation. This process of timeline reconstruction may be applied to any level of granularity with respect to entity cohorts to generate personalized timelines, such as a timeline for female patients undergoing pregnancy between the ages of 30 to 40, 20-year-old male patients diagnosed with type I diabetes living in a major urban center, etc.

In some embodiments, the system retrieves healthcare data related to a group of patients, a group of healthcare providers, and a group of procedures generally performed by the group of healthcare providers on the group of patients. The healthcare data generally includes insurance claims. The portion of healthcare data related to a procedure includes timing information associated with the procedure, such as the duration of the procedure, the start or end time of the procedure, and so on; the portion can also include information regarding cost, risk, success rate, or values of other attributes of the procedure. Upon receiving one or more healthcare criteria, the system determines a set of patients who satisfy the one or more healthcare criteria from the group of patents based on the healthcare data. Next, the system identifies a set of procedures performed on the set of patients from the group of procedures based on the healthcare data. As one example, the system can select frequently performed procedures. As another example, the system can eliminate common procedures that might not be specific to the one or more healthcare criteria from the group of procedures. The system can do so by identifying a separate set of procedures performed on a separate set of patients that do not satisfy the one or more healthcare criteria from calculating the term frequency-inverse document frequency (TF/IDF) or applying other known techniques.

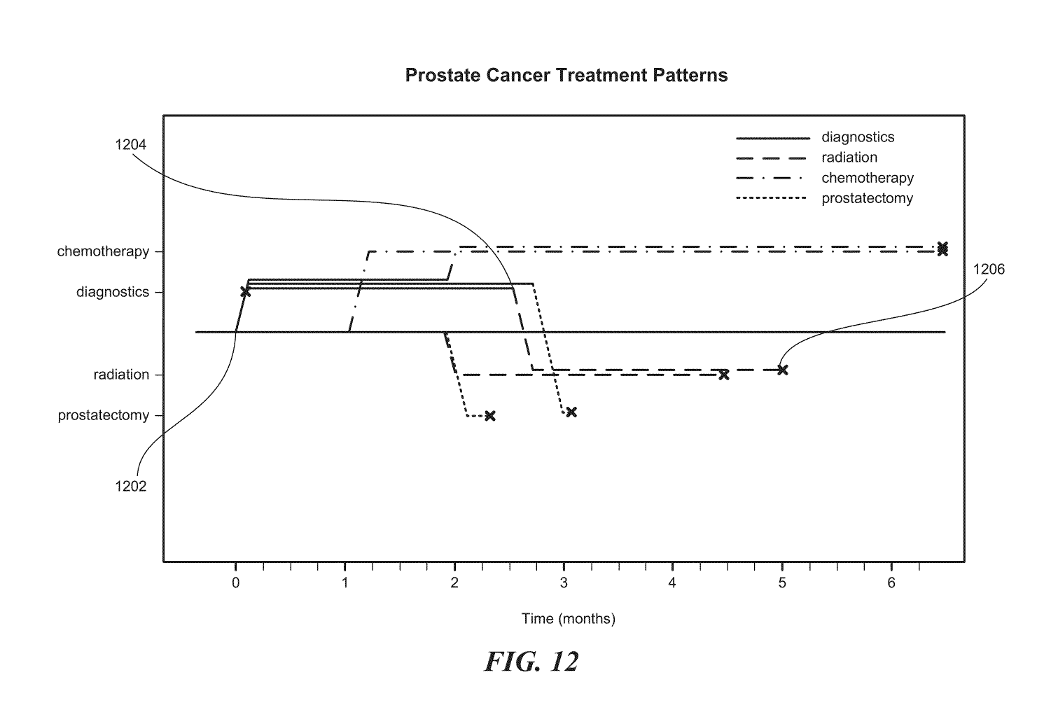

In some embodiments, the system next constructs at least one sequence of multiple procedures from the set of procedures based on the timing information associated with the set of procedures. For example, the system can first cluster the set of procedures based on the number of occurrences or co-occurrences or other attributes of the procedures, using hierarchical, K-means, or any other clustering technique known to someone of ordinary skill in the art. For example, procedures related to prostate cancer can be clustered into diagnosis, radiation, chemotherapy, treatment, and prostatectomy, where the diagnosis cluster can include body scan or prostate bioscopy, the radiation cluster can include imaging study interpretation and report or brachytherapy, the chemotherapy cluster can include Docetaxel, the treatment cluster can include Leuprolide or Denosumab, and the prostatectomy cluster can include prostatectomy or lymph node removal. The system can then construct an ordered combination of some of the clusters or a sequence of multiple procedures by including at most one procedure from each of the clusters. Each of these sequences then represents a typical treatment plan. FIG. 12 illustrates an example ordered combination of some of the clusters for prostate cancer. In one sequence, diagnosis starts at 1202 (around 0^{th} month) and ends at 1204 (around 2.5 months), and radiation starts afterwards and ends at 1206 (around 5 months). Each period can cover an operation, the accompanying preparation or recovery time, or even the waiting time until the next operation. Then, upon receiving a query regarding one of the at least one sequence of procedures from a user device of a user over a communication network, the system sends a response to the query to the user device.

In some embodiments, the system extracts values of a plurality of attributes of the procedures from the healthcare data and computes an aggregate of values for one of the plurality of attributes of a specific one of multiple procedures in one sequence of procedures in all performances on the set of patients on which the multiple procedures in the one sequence have been performed. The computation of an aggregate can be specific to the attribute. For example, when one of the plurality of attributes is a success status, the system computes the aggregate as the success rate over all the performances. The system can then respond to various queries regarding the one sequence of multiple procedures representing a specific treatment plan. Some examples are presented as follows. When the query requests an annual cost of the specific treatment plan, the system includes in the response a quotient of the aggregate cost for the one sequence and the aggregate time period of the one sequence in years. When the query requests a worst portion of the specific treatment plan for a specific one of the plurality of attributes, such as the costliest procedure, the system includes in the response an indication of one of the multiple procedures in the one sequence that has the highest aggregate for the specific one attribute. When the query requests an estimate of an overall value of a part of or the entirety of the specific treatment plan for a specific one of the plurality of attributes, the system includes in the response a sum or product of the aggregates over the part or entirety of the treatment plan for the specific one attribute depending on the nature of the specific one attribute. When the query requests the best of all the identified treatment plans for a specific one of the plurality of attributes, such as the treatment plan with the highest success rate, the system includes in the response a description of one of the at least one sequence with the best estimate of the overall value.

In some embodiments, the portion of the healthcare data related to a patient can include an assessment of current health condition for the patient, such as fully recovered or needing further treatment. The system can then compute an aggregate assessment of current health condition over the set of patients on which the specific treatment plan has been performed. Then, when the query requests the treatment plan that is most effective, the system includes in the response a description of one of the at least one sequence having the best aggregate assessment of current health condition. Furthermore, the system can compare the aggregate attribute values associated with the specific treatment plan, which represent typical, common values, with specific instances and report abnormalities in treatment histories. For example, the system can identify exceedingly high costs of certain performances of a specific procedure as potentially fraudulent charges. The system can also compare the identified treatment plans with specific instances and similarly report exceptions in treatment histories. For example, the system can identify a sequence of performed procedures that misses a procedure that is included in most of the identified sequences of procedures as a potentially deficient, ineffective treatment plan.

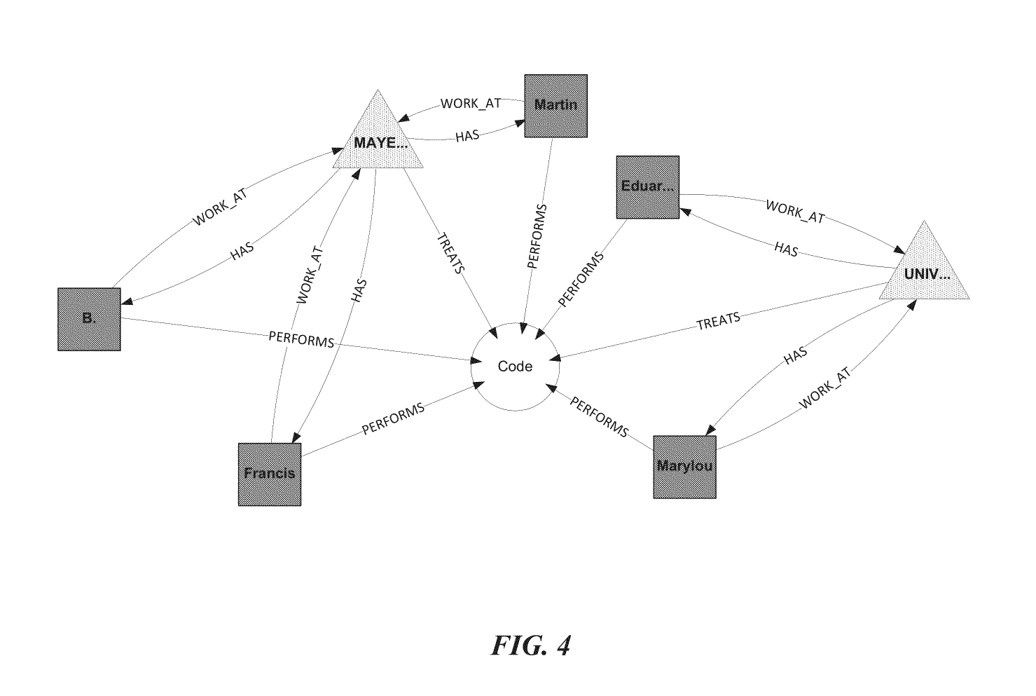

FIG. 4 is a flow diagram of a process for leveraging the existing electronic health data to generate comprehensive profiles of healthcare entities, according to one embodiment. By applying the system's statistical methodologies to large sets of health data, the system can create data-driven representations of interactions between healthcare entities, define relationships between healthcare entities and identify properties that characterize these relationships, and describe how interactions among healthcare entities relate to a plurality of outcomes, which may include cost, treatment options, disease management, patient-reported outcomes, provider-reported outcomes, and/or referral patterns. It should be noted that “high utilizers” contribute substantially to the overall cost of care in America. The system can identify “high utilizers” by leveraging existing electronic health data to generate comprehensive profiles of healthcare entities and the relationships between said healthcare entities.

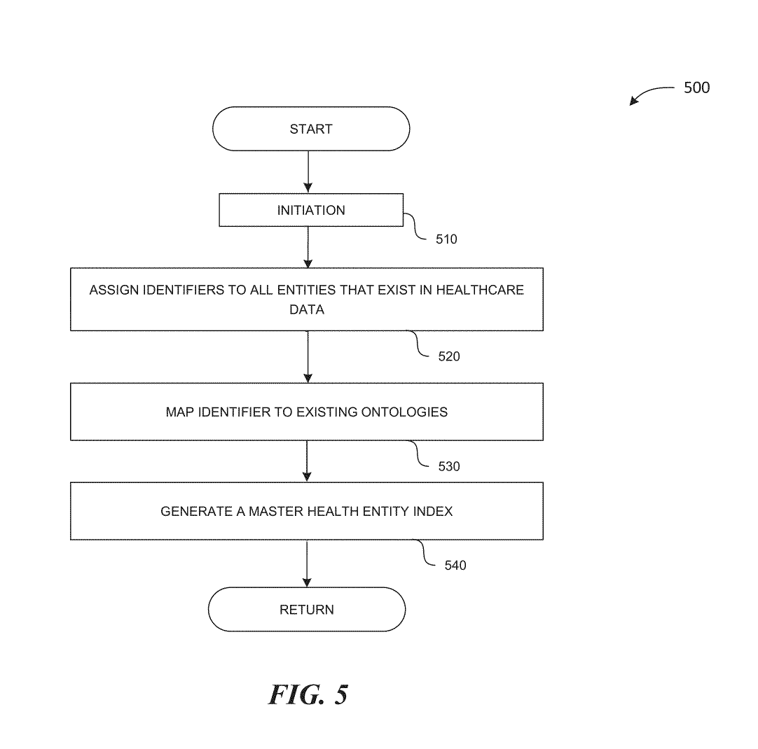

FIG. 5 is a flow diagram of a process 500 for generating a master health entity index, according to one embodiment. According to some embodiments, the system includes identifiers for actual health care entities that encompass all healthcare entities. In steps 510 and 520, the system may assign identifiers to all or some of the entities that exist in the health data. In steps 530 and 540, the system may map the identifier(s) to existing ontologies and generate a master health entity index. It should be noted that healthcare is a large, highly segmented industry with hundreds of millions of entities that include, but are not limited to, providers, consumers, suppliers, facilities, payers, contractors, conditions, treatments, and/or the relationships between them. It should also be noted that a comprehensive index of these entities and the relationships between them is a prerequisite for valid analyses of structure and unstructured data. Therefore, there is a need to assign each entity and relationship a unique identifier.

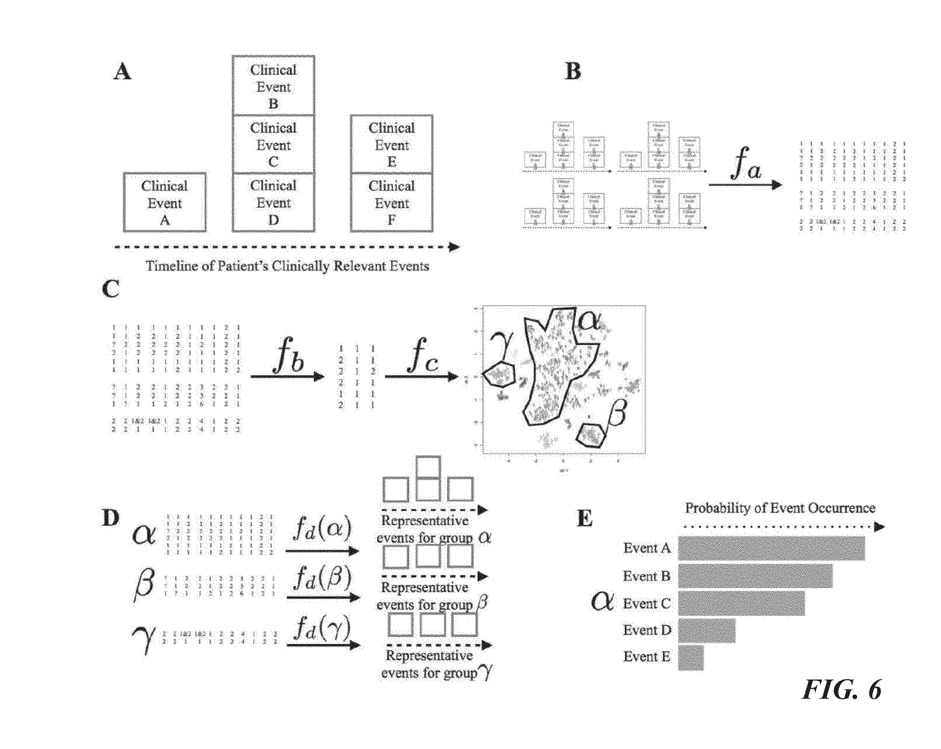

FIG. 6 illustrates an example of the phases of raw time-series medical data for patient cohorts and decision groups, according to one embodiment. There are five core steps: (A) for each patient of interest with specific cohort characteristics, such as age, gender or geographic location, medical record data exists that can be sorted according to some date (such as date of event or charge date in a claim); (B) the records are transformed using a function, such as logging the number of events per patient, f_a, into a numeric matrix such that each row corresponds to an individual patient and each column a type of clinically relevant event; (C) the dimensionality of the numeric matrix is reduced via f_b (e.g., using projection methods) and grouped using f_c (using hierarchical clustering techniques) such that patients which experience similar events are placed in the same cluster (in the above plate, alpha, beta and gamma, delineated by solid lines, represent three possible clusters); (D) for each identified cluster, a scoring function f_d is used to identify the most quantitatively representative patient encounter; and (E) for each cluster, the empirical probability of the events in the representative patient encounter are displayed to the user.

Data analysis methods are used to identify, segment, and describe “provider cohorts,” which are populations of providers with similar characteristics. Provider cohorts may share any combinations of characteristics, including (but not limited to) sex, age, location, medical specialties and subspecialties, medical facility affiliations, medical school(s) attended, medical board certifications, patient cohorts treated, medical services rendered to patients, and insurance plans accepted.

The methods used for describing and segmenting patient cohorts can be employed to determine provider cohorts, with some minor adjustments. Whereas for patient cohorts, initial filtering is done based on demographic information, presently we can filter patients based on provider type. For example, only patients of and patient events done by gastroenterologists would constitute a characteristic. The process noted for patient cohorts would then proceed as before, and an additional step would take place at the conclusion of phase (C) in FIG. 6. Throughout the steps outlined for patient cohort selection, the provider is also tracked per patient. When clustering at phase (C) is conducted, the providers in each group (e.g., groups alpha, beta, gamma) can be identified as being similar. The precise determination of similarity can be done purely on the providers in a group or thresholds (by count (e.g., minimum number of patients per provider) or by fraction (e.g., a certain percentage of patients in a group for each provider) that may be used to present a truncated list.

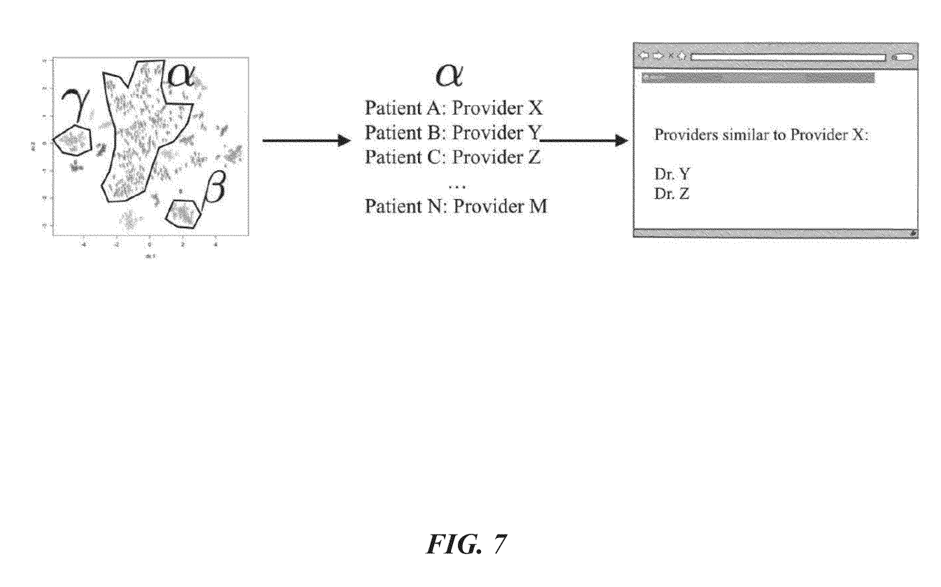

FIG. 7 illustrates an example of the extension of the patient cohort and decision group identification process for providers, according to one embodiment. Continuing at phase (C), the providers for patients in each distinct group (in the above example, group alpha) are identified and presented to the user as similar to each other for the purposes of finding relevant providers.

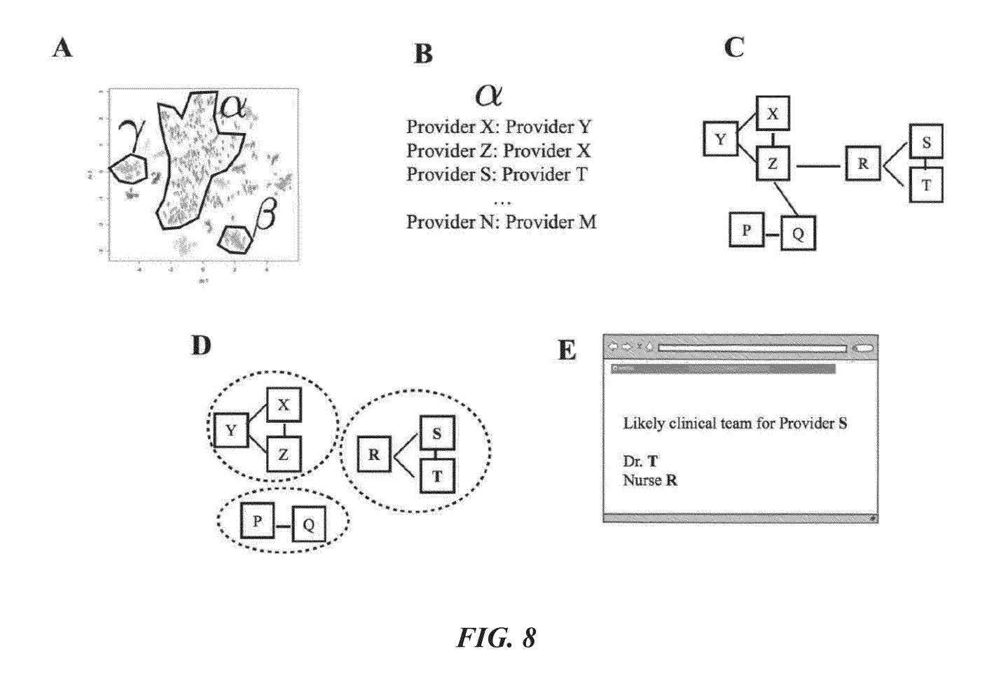

While the above takes into account identifying and presenting to the user sets of providers by similarity, additional views are generated based on affiliation; that is, sets of providers that may not necessarily be related as defined in [0042], but perhaps belong to a similar referral network or are otherwise found to be cooperating with each other over the same patients (cf. FIG. 8).

Based on the user's specific personalization of the characteristics of interest (age, gender, geographic location, etc.), the system constructs a clustering, per-patient cohort methodology (A). Likewise, per identifying similar providers, a mapping is generated (B); however, for the purposes of affiliated providers, unlike similar providers, this mapping is based on provider relation. Here, the system defines relation as any relationship that connects two providers together, such as patient referral, practice facility, or even shared patients. This is computed directly from the medical data, and relates in 1:1 form a provider with other providers. In 1:1 form, these relations are translated into an adjacency matrix as follows: define C as the set of providers that treated a group of patients in a cluster, and let p_x represent any provider within C. Suppose R(p_i, p_j)>0 if a relation exists between providers p_i and p_j, and R(p_i, p_j)=0 otherwise; then define a matrix M, where each value M_{i,j}=R(p_i, p_j), such that M is directly interpretable as an adjacency matrix. M is then used to construct a network of provider relationships (C), upon which modularity/community detection algorithms are employed to identify groupings of providers (D). These groups can then be presented to the user as sets of providers, specific for the characteristics they defined earlier, that are strongly related to any other provider. Notably, this can be done on a user-specified basis on a subset of providers, and thus is personalized to the individual user.

FIG. 8 illustrates an example of the proceeding to find affiliated providers from identification of similar providers, according to one embodiment. Starting again at the clustering phase (A), we generate a list of similar providers based on clustering. Connections are constructed such that each provider may connect to one or more other providers based on referral, shared patients or other useful characteristics (B). This amounts mathematically to an adjacency matrix, from which a network is constructed (C) (note that the edges in this network may be weighted by additional information, such as frequency of referral or number of patients). Any number of known community detection techniques is then used to identify groups of providers that relate to one another (D). Finally, an interface is presented to the user that provides a list of a likely care/provider team for that user's set characteristics. In the above example, a related group of providers R, S and T are identified and presented to the user.

Data analysis methods are used to identify, segment, and describe characteristics of “facility cohorts,” which are collections of facilities with similar characteristics. Facility cohorts may share any combination of characteristics, including (but not limited to) location, facility type, affiliated facilities, affiliated physicians, affiliated physician cohorts, facility size attributes, facility departments, facility accreditation, patient cohorts treated, medical services rendered to patients, and insurance plans accepted. As for providers, extensions to the patient cohort approach can track facilities during phase (C), resulting in facilities that share similar treatments regimes. In practice, the matrix and thus the network generated to extend the provider cohort approach (cf. FIG. 8) to facilities requires additional relationships between facilities, such as providers affiliated with more than one facility and geographic distance.

Regarding data analysis methods used to predict medical event costs over time, during the calculation of medical event groupings and representative medical events for a set of patients with a given characteristic, we can simultaneously generate a prediction of the overall cost. Tracking patient costs throughout the process, we add another extension at the clustering step. If medical cost data is provided at the event level, we aggregate up to the patient level for a specified time frame; otherwise, if costs are at the patient level, they are retained. Total aggregate costs for each patient are calculated for each grouping, and using density estimation techniques a cost curve is imputed for presentation to the user. This provides the user with a personalized estimate of costs by patient cohort/decision group type, customized by their predefined age/gender/geographic location/etc. characteristics for any procedure or condition.

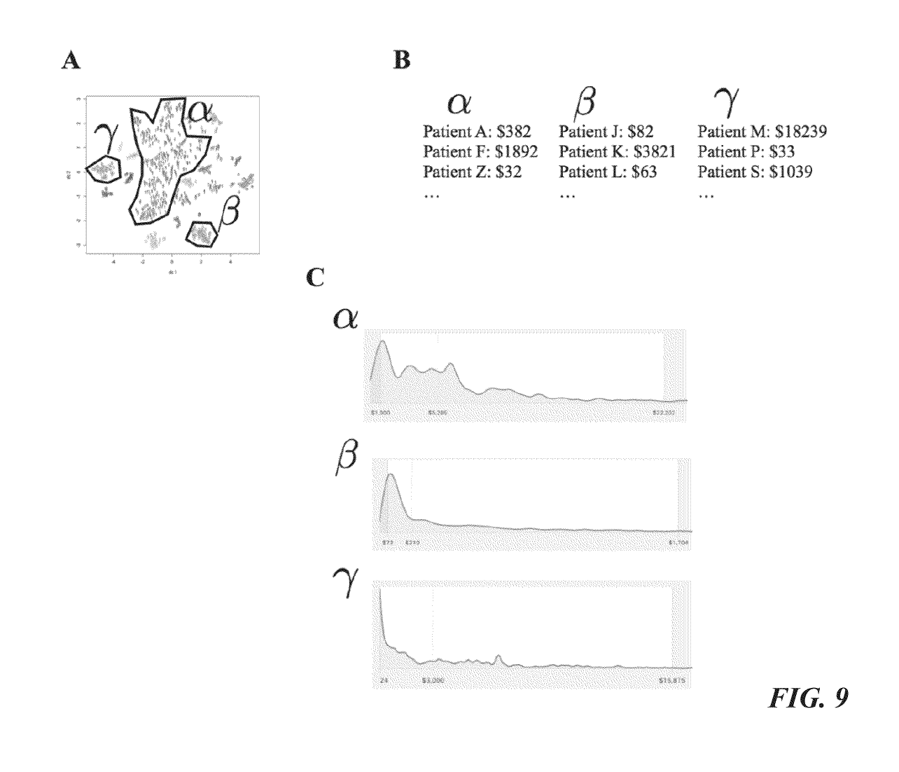

FIG. 9 illustrates an example of the direct calculation of likely costs based on patient clusters and discrete decision groups, according to one embodiment. For each grouping identified in the patient clustering phase (A), per-patient costs are calculated at the service line level and aggregated up to the total patient cost for the given time frame (B). Density estimation techniques are then used to smooth over the costs and provide to the user an imputed cost curve representing an expected cost span for the patient demographics and characteristics of choice (C). Depending on the time frame that is set, this can be done to predict cohort costs for a medical procedure, annual cost for a chronic condition, chemotherapy treatment costs on a monthly basis, etc.

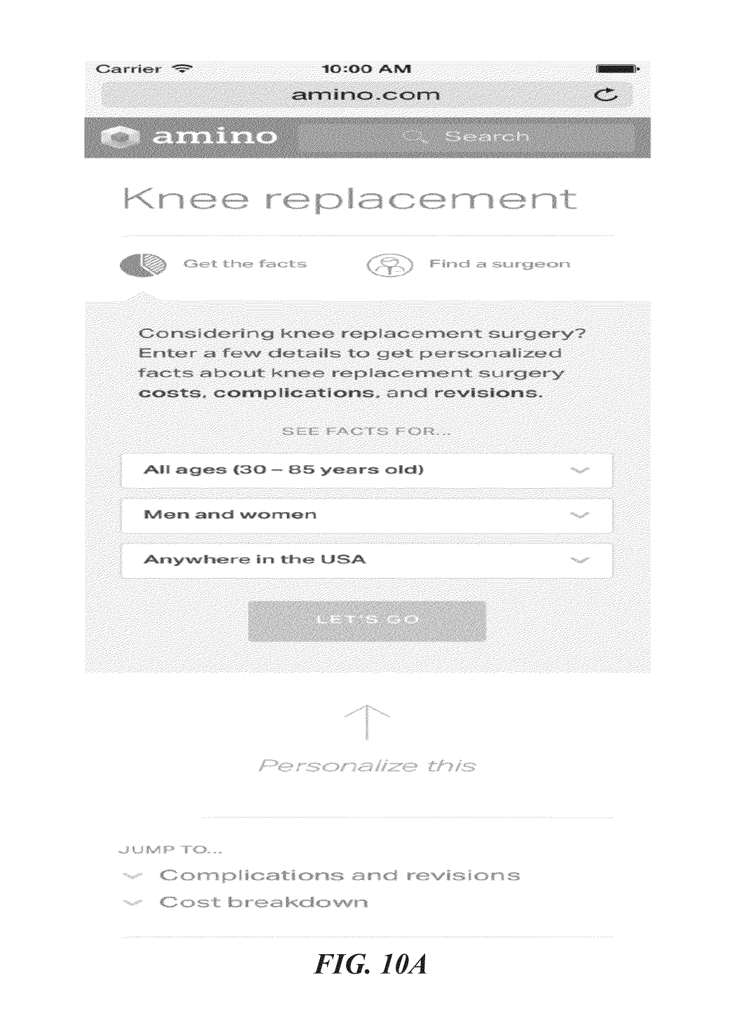

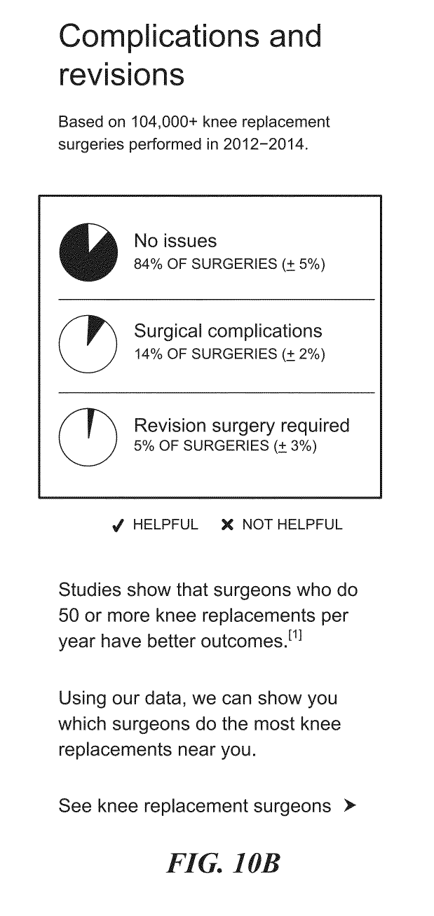

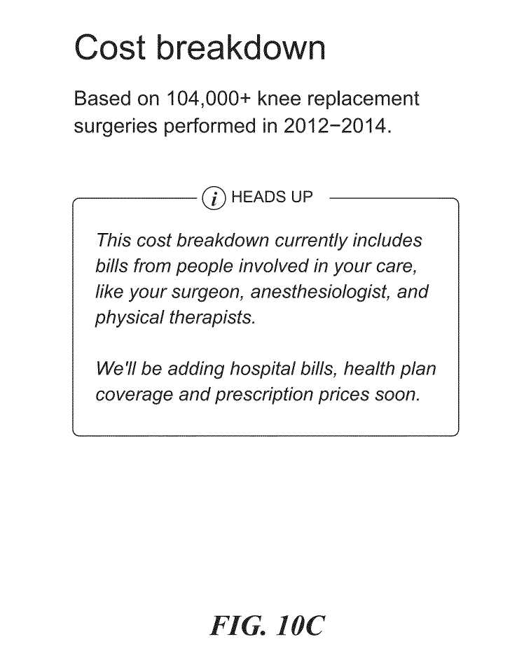

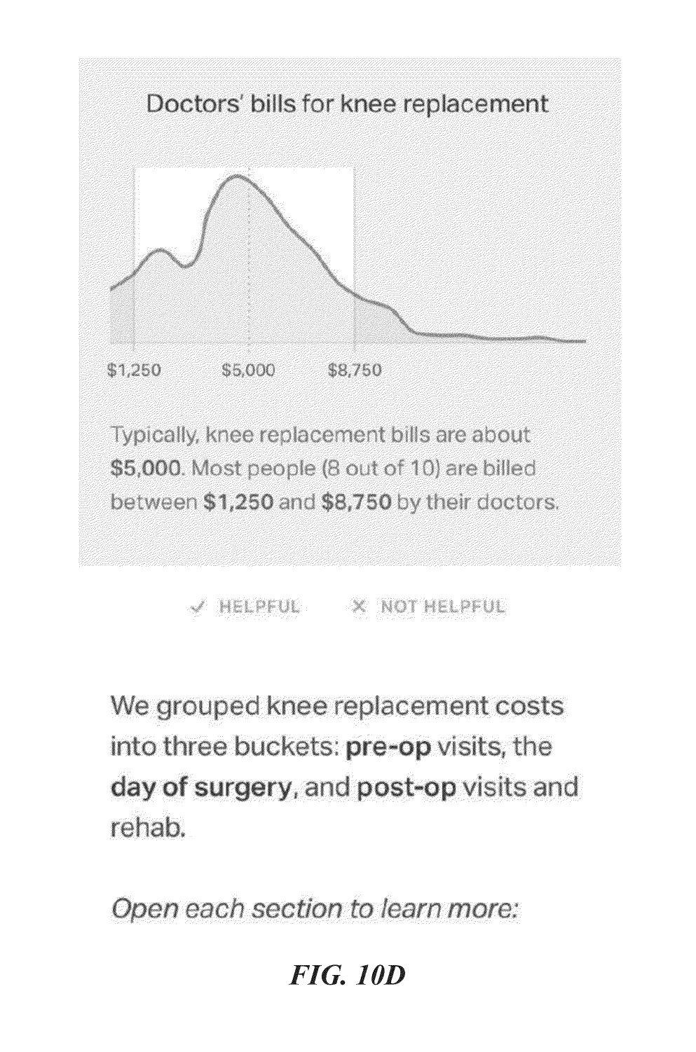

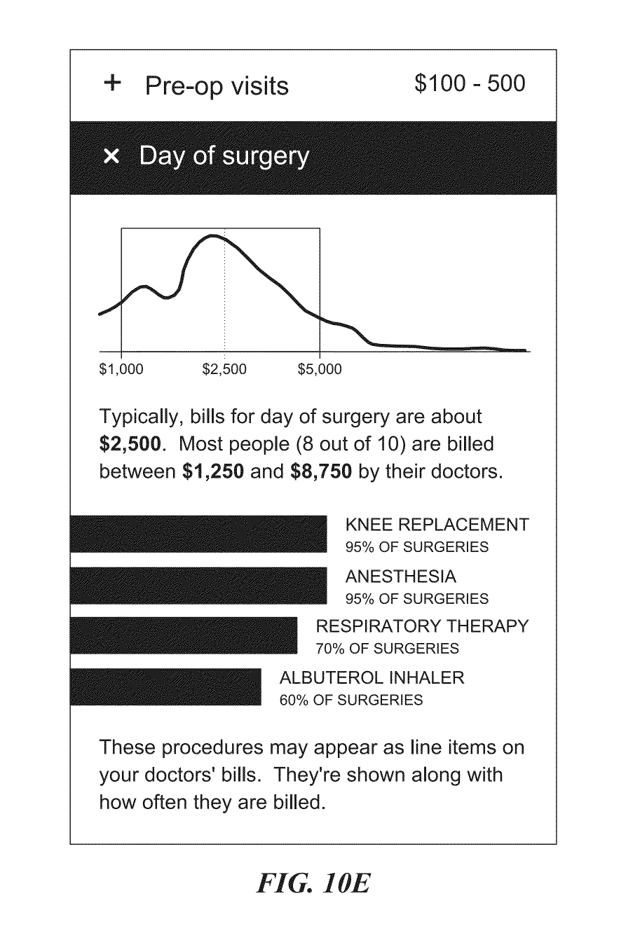

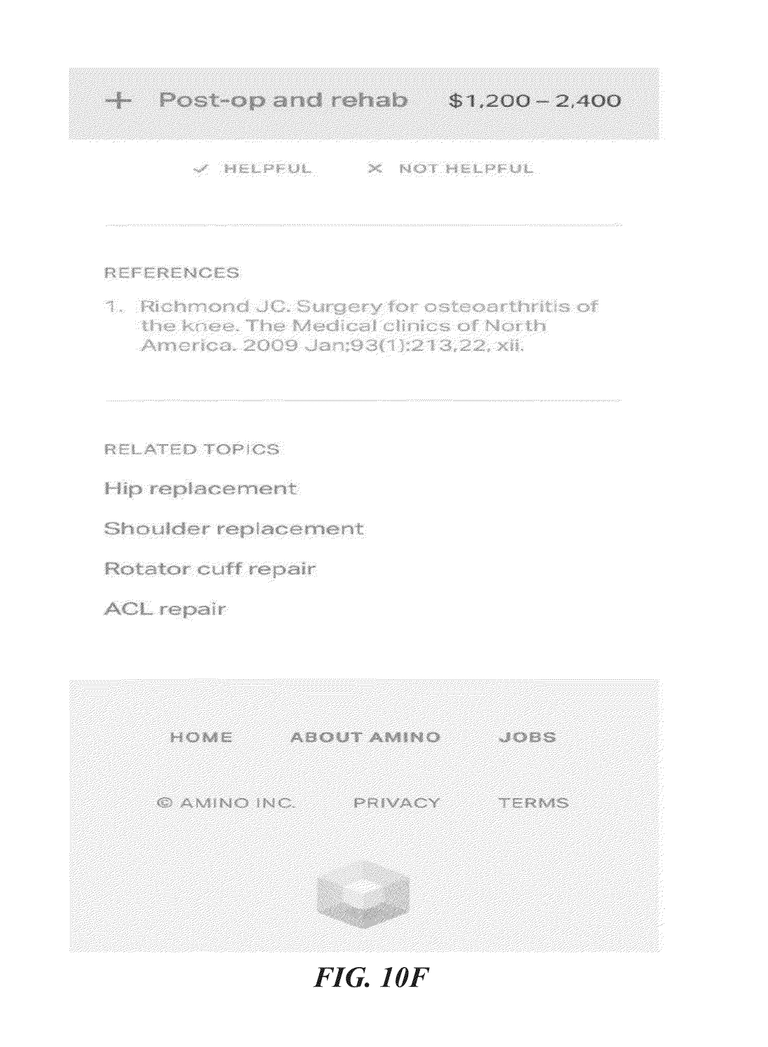

FIGS. 10A-10F illustrate examples of various graphical user interfaces of healthcare applications generated by a system, such as the system of FIG. 1, for providing personalized cost, treatment and outcome predictions based on entity cohort discovery and entity profiling, according to one embodiment.

Regarding visualizations, user interfaces, and application functionality, user interfaces allow users to select any cohort about which to display historical data and/or predictions about what events that cohort may experience with regard to a specific medical condition, medical procedure, medical specialty, geographical region where care is received, medical facility type, specific care provider, specific care facility, medical device, medication, health insurance network, health insurance plan, other medical treatments, or other types of medical encounters.

For any given topic (medical condition, medical procedure, etc.), the user interface provides one or more filters that allow the user to specify one or more attributes of the cohort of interest.

The number of options available in each filter is the smallest number of options required to offer the user the maximum number of statistically meaningful variations in the resulting data, as determined by our data analysis methods.

User interfaces are used to show historical data and predictions about interactions between patient cohorts, individual providers, provider cohorts, individual facilities, facility cohorts, individual health plans, health plan cohorts, and other concept cohorts. User interface components include: (1) The cohort selector described above; (2) A collection of one or more episodes of medical care experienced by a given cohort for a specific medical condition, treatment, or other medical encounter of interest; and (3) individual episodes of care represented as expandable and collapsible sections in the user interface, where descriptive labels and summary statistics about the episode appear in the collapsed state.

The user interface for the collapsed state allows a user to click, hover, voice command, or tap to see the expanded state. In the expanded state, the episode is represented more granularly with graphical and textual representations of treatment components, outcomes, types of care providers and facilities involved, billed costs, remitted costs, patient costs, and other aspects of the medical care involved. In the expanded state, descriptive numerical statistics are incorporated into the graphical and textual components to illustrate concepts including, but not limited to, the observed frequency of an event, the predicted likelihood of an event, averages, ranges, percentiles, standard deviations, and margins of error. In both the expanded and collapsed views, the user interface provides tooltips: visual elements which, when clicked, tapped, voice commanded or hovered, allow users to see more detailed narrative descriptions about the episode of care or its constituent parts.

User interfaces are used to provide personalized “call to action” links to other relevant portions of the application based on their selected cohort and a given medical topic. Types of calls to action include:

Calls to action to visit historical data and predictions for topics related to the topic the user is currently viewing (e.g., a user viewing information on spinal fusion surgery might, for some cohort selections, see a prompt to visit the related topic of back pain); and

Calls to action to search for individual medical care providers related to the topic the user is currently viewing (e.g., a user viewing information about breast cancer treatment for the cohort of females in the NYC area would see a link to find a breast cancer specialist in the NYC area using our application's doctor search functionality).

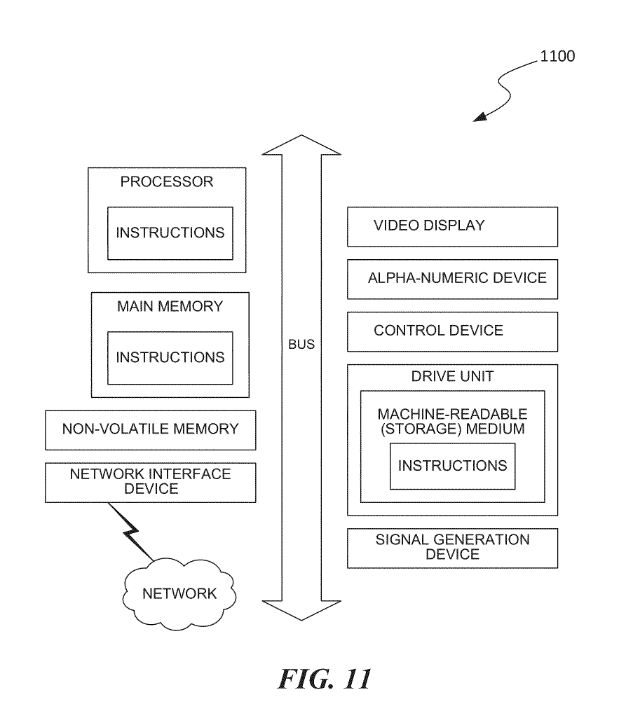

Referring now to FIG. 11, therein is shown a diagrammatic representation of a machine in the example form of a computer system 1100 within which a set of instructions for causing the machine to perform any one or more of the methodologies or modules discussed herein may be executed.

In the example of FIG. 11, the computer system 1100 includes a processor, memory, non-volatile memory, and an interface device. Various common components (e.g., cache memory) are omitted for illustrative simplicity. The computer system 1100 is intended to illustrate a hardware device on which any of the components described in the examples of FIGS. 1-10 (and any other components described in this specification) can be implemented. The computer system 1100 can be of any applicable known or convenient type. The components of the computer system 1100 can be coupled together via a bus or through some other known or convenient device.

This disclosure contemplates the computer system 1100 taking any suitable physical form. As example and not by way of limitation, the computer system 1100 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, the computer system 1100 may include one or more computer systems 1100; be unitary or distributed; span multiple locations; span multiple machines; or reside in a cloud, which may include one or more cloud components in one or more networks. Where appropriate, one or more computer systems 1100 may perform without substantial spatial or temporal limitation one or more steps of one or more methods described or illustrated herein. As an example and not by way of limitation, one or more computer systems 1100 may perform in real time or in batch mode one or more steps of one or more methods described or illustrated herein. One or more computer systems 1100 may perform at different times or at different locations one or more steps of one or more methods described or illustrated herein, where appropriate.

The processor may be, for example, a conventional microprocessor such as an Intel Pentium microprocessor or Motorola power PC microprocessor. One of skill in the art will recognize that the terms “machine-readable (storage) medium” or “computer-readable (storage) medium” include any type of device that is accessible by the processor.

The memory is coupled to the processor by, for example, a bus. The memory can include, by way of example but not limitation, random access memory (RAM), such as dynamic RAM (DRAM) and static RAM (SRAM). The memory can be local, remote, or distributed.

The bus also couples the processor to the non-volatile memory and drive unit. The non-volatile memory is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software in the computer system 1100. The non-volatile storage can be local, remote, or distributed. The non-volatile memory is optional because systems can be created with all applicable data available in memory. A typical computer system will usually include at least a processor, memory, and a device (e.g., a bus) coupling the memory to the processor.

Software is typically stored in the non-volatile memory and/or the drive unit. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this document. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable medium.” A processor is considered to be “configured to execute a program” when at least one value associated with the program is stored in a register readable by the processor.

The bus also couples the processor to the network interface device. The interface can include one or more of a modem or network interface. It will be appreciated that a modem or network interface can be considered to be part of the computer system 1100. The interface can include an analog modem, ISDN modem, cable modem, token ring interface, satellite transmission interface (e.g., “direct PC”), or other interfaces for coupling a computer system to other computer systems. The interface can include one or more input and/or output devices. The I/O devices can include, by way of example but not limitation, a keyboard, a mouse or other pointing device, disk drives, printers, a scanner, and other input and/or output devices, including a display device. The display device can include, by way of example but not limitation, a cathode ray tube (CRT), liquid crystal display (LCD), or some other applicable known or convenient display device. For simplicity, it is assumed that controllers of any devices not depicted in the example of FIG. 11 reside in the interface.

In operation, the computer system 1100 can be controlled by operating system software that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux™ operating system and its associated file management system. The file management system is typically stored in the non-volatile memory and/or drive unit and causes the processor to execute the various acts required by the operating system to input and output data and to store data in the memory, including storing files on the non-volatile memory and/or drive unit.

Some portions of the Detailed Description may be presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “generating” or the like refer to the actions and processes of a computer system, or similar electronic computing device, that manipulate and transform data represented as physical (electronic) quantities within the computer system's registers and memories into other data similarly represented as physical quantities within the computer system's memories or registers or other such information storage, transmission or display devices.

The algorithms and displays presented herein are not inherently related to any particular computer or other apparatus. Various general purpose systems may be used with programs in accordance with the teachings herein, or it may prove convenient to construct more specialized apparatus to perform the methods of some embodiments. The required structure for a variety of these systems will appear from the description below. In addition, the techniques are not described with reference to any particular programming language, and various embodiments may thus be implemented using a variety of programming languages.

In alternative embodiments, the machine operates as a stand-alone device or it may be connected (e.g., networked) to other machines. In a networked deployment, the machine may operate in the capacity of a server or a client machine in a client-server network environment, or as a peer machine in a peer-to-peer (or distributed) network environment.

The machine may be a server computer, a client computer, a personal computer (PC), a tablet PC, a laptop computer, a set-top box (STB), a personal digital assistant (PDA), a cellular telephone, a processor, a telephone, a web appliance, a network router, switch or bridge, or any machine capable of executing a set of instructions (sequential or otherwise) that specify actions to be taken by that machine.

While the machine-readable medium or machine-readable storage medium is shown in an exemplary embodiment to be a single medium, the term “machine-readable medium” and “machine-readable storage medium” should be taken to include a single medium or multiple media (e.g., a centralized or distributed database and/or associated caches and servers) that store the one or more sets of instructions. The term “machine-readable medium” and “machine-readable storage medium” shall also be taken to include any medium that is capable of storing, encoding or carrying a set of instructions for execution by the machine and that cause the machine to perform any one or more of the methodologies or modules of the presently disclosed technique and innovation.

In general, the routines executed to implement the embodiments of the disclosure may be implemented as part of an operating system or a specific application, component, program, object, module or sequence of instructions referred to as “computer programs.” The computer programs typically comprise one or more instructions set at various times in various memory and storage devices in a computer, and that, when read and executed by one or more processing units or processors in a computer, cause the computer to perform operations to execute elements involving the various aspects of the disclosure.

Moreover, while embodiments have been described in the context of fully functioning computers and computer systems, those skilled in the art will appreciate that the various embodiments are capable of being distributed as a program product in a variety of forms, and that the disclosure applies equally regardless of the particular type of machine or computer-readable media used to actually effect the distribution.

Further examples of machine-readable storage media, machine-readable media, or computer-readable (storage) media include, but are not limited to, recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others, and transmission type media such as digital and analog communication links.

In some circumstances, operation of a memory device, such as a change in state from a binary one to a binary zero, or vice versa, for example, may comprise a transformation, such as a physical transformation. With particular types of memory devices, such a physical transformation may comprise a physical transformation of an article to a different state or thing. For example, but without limitation, for some types of memory devices, a change in state may involve an accumulation and storage of charge or a release of stored charge. Likewise, in other memory devices, a change of state may comprise a physical change or transformation in magnetic orientation or a physical change or transformation in molecular structure, such as from crystalline to amorphous, or vice versa. The foregoing is not intended to be an exhaustive list of all examples in which a change in state for a binary one to a binary zero, or vice versa, in a memory device may comprise a transformation, such as a physical transformation. Rather, the foregoing are intended as illustrative examples.

A storage medium typically may be non-transitory or comprise a non-transitory device. In this context, a non-transitory storage medium may include a device that is tangible, meaning that the device has a concrete physical form, although the device may change its physical state. Thus, for example, non-transitory refers to a device remaining tangible despite this change in state.

The above description and drawings are illustrative and are not to be construed as limiting the invention to the precise forms disclosed. Persons skilled in the art can appreciate that many modifications and variations are possible in light of the above disclosure. Numerous specific details are described to provide a thorough understanding of the disclosure. However, in certain instances, well-known or conventional details are not described in order to avoid obscuring the description.

References in this specification to “one embodiment” or “an embodiment” mean that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described that may be exhibited by some embodiments and not by others. Similarly, various requirements are described that may be requirements for some embodiments but not other embodiments.

Unless the context clearly requires otherwise, throughout the description and the claims, the words “comprise,” “comprising,” and the like are to be construed in an inclusive sense, as opposed to an exclusive or exhaustive sense, that is to say, in the sense of “including, but not limited to.” As used herein, the terms “connected,” “coupled,” or any variant thereof, mean any connection or coupling, either direct or indirect, between two or more elements; the coupling or connection between the elements can be physical, logical, or any combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

While processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the disclosure provided herein can be applied to other systems, not necessarily the system described above. The elements and acts of the various embodiments described above can be combined to provide further embodiments.

These and other changes can be made to the disclosure in light of the above Detailed Description. While the above Detailed Description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific embodiments disclosed in the specification, unless the above Detailed Description section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. §112, ¶6, other aspects may likewise be embodied as a means-plus-function claim, or in other forms, such as being embodied in a computer-readable medium. (Any claims intended to be treated under 35 U.S.C. §112, ¶6 will begin with the words “means for.”) Accordingly, the applicant reserves the right to add additional claims after filing the application to pursue such additional claim forms for other aspects of the disclosure.

The terms used in this specification generally have their ordinary meanings in the art, within the context of the disclosure, and in the specific context where each term is used. Certain terms that are used to describe the disclosure are discussed above, or elsewhere in the specification, to provide additional guidance to the practitioner regarding the description of the disclosure. For convenience, certain terms may be highlighted, for example using capitalization, italics and/or quotation marks. The use of highlighting has no influence on the scope and meaning of a term; the scope and meaning of a term is the same, in the same context, whether or not it is highlighted. It will be appreciated that same elements can be described in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meanings as commonly understood by one of ordinary skill in the art to which this disclosure pertains. In the case of conflict, the present document, including definitions, will control.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer-readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer-readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this Detailed Description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method performed by a computer comprising a processor and a memory of recommending customized healthcare treatment, comprising:
retrieving, by the computer, healthcare data related to a group of patients, a group of healthcare providers, and a group of procedures performed by the group of healthcare providers on the group of patients,
wherein the healthcare data related to a procedure includes timing information associated with the procedure;
receiving, by the computer, one or more healthcare criteria;
determining, by the computer, a set of patients who satisfy the one or more healthcare criteria from the group of patents based on the healthcare data;
identifying, by the computer, a set of procedures performed on the set of patients from the group of procedures based on the healthcare data;
constructing, by the computer, at least one sequence of multiple procedures from the set of procedures based on the timing information associated with the set of procedures;
receiving, by the computer, a query regarding one of the at least one sequence of procedures from a user device of a user over a communication network; and
sending, by the computer, a response to the query to the user device.

2. The method of claim 1, wherein the healthcare data includes insurance claims.

3. The method of claim 1,
wherein the constructing includes clustering the set of procedures, and
wherein the multiple procedures belong to different clusters.

4. The method of claim 1, further comprising:
determining a second set of patients that do not satisfy the set of healthcare criteria from the group of patients based on the healthcare data; and
identifying a second set of procedures performed on the second set of patients from the group of procedures based on the healthcare data,
wherein identifying the set of procedures excludes any procedure in the second set.

5. The method of claim 1,
wherein each of the multiple procedures in the one sequence has a common plurality of attributes, and
wherein the healthcare data related to the group of procedures includes at least one value for one of the plurality of attributes of one of the multiple procedures in one performance of the one procedure on one of the set of patients.

6. The method of claim 5, wherein the plurality of attributes includes a time period, a cost, or an amount of risk associated with a procedure.

7. The method of claim 5, further comprising computing an aggregate of values for one of the plurality of attributes of a specific one of the multiple procedures in the one sequence in all performances on the set of patients on which the multiple procedures in the one sequence have been performed from the healthcare data.

8. The method of claim 7,
wherein the plurality of attributes includes a time period and a cost,
wherein the query requests an annual cost of the one sequence, and
wherein the response indicates a quotient of the aggregate cost for the one sequence and the aggregate time period in years.

9. The method of claim 7,
wherein one of the plurality of attributes is a success status, and
wherein the aggregate for the success status is the success rate over all the performances.

10. The method of claim 7,
wherein the query requests a worst portion of the one sequence for a specific one of the plurality of attributes, and
wherein the response indicates one of the multiple procedures in the one sequence that has the highest aggregate for the specific one attribute.

11. The method of claim 7, further comprising, when the query requests an estimate of an overall value of at least a part of the multiple procedures in the one sequence for a specific one of the plurality of attributes, the response includes a sum or product of the aggregates for the specific one attribute over the at least part of the multiple procedures.

12. The method of claim 7,
wherein the query requests the best of the at least one sequence for a specific one of the plurality of attributes,
further comprising:
computing a sum or product of the aggregates for the specific one attribute over the multiple procedures in each of the at least one sequence; and
sending to the user device a description of one of the at least one sequence with the smallest aggregate.

13. The method of 7,
wherein the healthcare data includes an assessment of current health condition for each of the group of patients,
further comprising
for each of the at least one sequence, computing an aggregate assessment of current health condition over the set of patients on which the multiple procedures in the one sequence have been performed,
where the query requests one of the at least one sequence leading to the best health condition,
wherein the response includes a description of one of the at least one sequence having the best aggregate assessment of current health condition.

14. The computer-implemented method of claim 7, further comprising:
for a specific one of the plurality of attributes of a specific one of the multiple procedures in the one sequence, identifying a performance of the specific one procedure on one of the set of patients where a value of the specific one attribute is greater than the aggregate for the one attribute by at least a certain amount; and
generating a report of the identified performances.

15. The method of claim 5,
wherein the timing information includes a start time in a performance of one of the multiple procedures in the one sequence, and
wherein one of the plurality of attributes is a duration between a start time of the one procedure in the one sequence and a start time of the next procedure in the one sequence.

16. The method of claim 1, wherein the timing information includes a start time or an end time of the one procedure or a total amount of time taken by the one procedure.

17. The method of claim 1,
wherein the query includes a specific sequence of procedures, and
wherein the response indicates a difference between the specific sequence and the one sequence.

18. The method of claim 15, wherein the difference includes a procedure in the one sequence but not in the specific sequence.

19. The method of claim 1, wherein the set of one or more healthcare criteria includes having a medical condition, symptom, or disease.

20. The method of claim 1, wherein the constructing includes identifying the at least one sequence of the multiple procedures as the sequence that most frequently occurs to the set of patients from the healthcare data.

21. The method of claim 1, wherein the one or more healthcare criteria are received from the user device.
